(19) United States
(12) Patent Application Publication
(10) Pub. No.: US 2003/0231323 A1
(43) Pub. Date: Dec. 18, 2003

(54) Method of and system for performing double-side printing image data of various sizes

(76) Inventor: Kazuhiro Satoh, Kawasaki-shi (JP)

Correspondence Address: KNOBLE & YOSHIDA, LLC, Suite 1350, Eight Penn Center, 1628 John F. Kennedy Blvd, Philadelphia, PA, 19103, US

(21) Appl. No.: 10/453,208

(22) Filed: Jun. 3, 2003

(30) Foreign Application Priority Data
Jun. 17, 2002 (JP) 2002-175162

(51) Int. Cl. B41B 1/00; G06F 15/00

(52) U.S. Cl. 358/1.2

(57) ABSTRACT

Information is printed on both sides of a recording medium such as paper even though the original information contains various output sizes. To determine an appropriate paper size for double-side printing, predetermined sets of rules are described. In general, the rules can be grouped into a multiple-page processing scheme and a two-page processing scheme. In the multiple-page processing scheme, a single paper size is selected for multiple pages. On the other hand, in the two-page processing scheme, a paper size is selected for two consecutive pages at a time.

### FIELD OF THE INVENTION

The current invention is generally related to printing image data, and more particularly related to a method of and a system for performing double-side printing of image data of various sizes.

### BACKGROUND OF THE INVENTION

Copiers or duplicators have been known to copy images from both sides of originals and to output images on both sides of recording paper. In the modern communication devices and facsimile machines in particular, the above two-side or double-side printing function has been added. Not only the image information that has been read from the front and the back of the same original is printed, but also the image information that has been read from the originals of various sizes is printed on both sides of paper. Furthermore, there are other situations where the image data includes the image information each of which is of a different size.

In improving the double-side printing, a number of prior art attempts has been made as will be described in the following. Japanese Patent Publication 2001-211309 discloses that a facsimile machine that prints image data on a sheet of paper that is later folded in half. Although the disclosure mentions the front side and the back side of the paper after it is folded, the double-side printing in the current application means that the front side and the back side of a print out without folding the paper. Japanese Patent 3178466 discloses that double-side printing takes place if the requested has been made and the original image size is the same among the image data The image data size is checked only when the double side printing has been specified by the user. Japanese Patent 3076158 discloses a facsimile machine that is designed to print transmission data over multiple transmissions on both sides of paper upon request. If the double-side printing has been specified, it is determined whether or not the image data has been received in its entirety in a single transmission. If the image data has not been transmitted in a single transmission, the double-side printing is delayed at least for a predetermined amount of time for the subsequent transmissions. However, the disclosure mentions nothing about paper size for the double-side printing.

The above prior attempts have not considered the double-side printing of image data of various sizes. Since the direction application of the above relevant prior attempts does not does not solve the requirements for double-printing image data of various sizes, it remains desirable to print the received image data on both sides of paper in a reasonable and useful manner.

### SUMMARY OF THE INVENTION

In order to solve the above and other problems, according to a first aspect of the current invention, a method of performing double-side printing, including the steps of: receiving image data having a plurality of pages of multiple sizes to be printed with a corresponding descriptive data file in a predetermined format, the descriptive data file having at least information on an image size of each of the pages; comparing the image size of at least two consecutive ones of the pages to generate a comparison result; selecting a recording medium size based upon the comparison result according to a predetermined rule; and printing the pages on a front side and a back side of a recording medium of the selected recording medium size.

According to a second aspect of the current invention, a method of performing double-side printing, including the steps of: inputting image data having a plurality of pages of multiple sizes to be printed with a corresponding descriptive data file in a predetermined format, the descriptive data file having at least information on an image size of each of the pages; comparing the image size of two consecutive ones of the pages at a time to generate a comparison result; selecting a recording medium size based upon the comparison result according to a predetermined rule; and printing the two consecutive pages on a recording medium of the selected recording medium size, wherein when the comparison result indicates two different sizes, a first one of the two consecutive pages is printed on the front side of the recording medium of a corresponding one of the two different sizes and a second one of the two consecutive pages is printed on the front side of the recording medium of the other one of the two different sizes, wherein when the comparison result indicates a common size, a first one of the two consecutive pages is printed on the front side of the recording medium of the common size and a second one of the two consecutive pages is printed on the back side of the same recording medium.

According to a third aspect of the current invention, a system for performing double-side printing, including: a memory for receiving image data having a plurality of pages of multiple sizes to be printed with a corresponding descriptive data file in a predetermined format, the descriptive data file having at least information on an image size of each of the pages; a processing unit connected to the memory for comparing the image size of at least two consecutive ones of the pages to generate a comparison result, the processing unit selecting a recording medium size based upon the comparison result according to a predetermined rule; and a printer connected to the processing unit for printing the pages on a front side and a back side of a recording medium of the selected recording medium size.

According to a second fourth aspect of the current invention, a system for performing double-side printing, including: a memory for receiving image data having a plurality of pages of multiple sizes to be printed with a corresponding descriptive data file in a predetermined format, the descriptive data file having at least information on an image size of each of the pages; a processing unit connected to the memory for comparing the image size of two consecutive ones of the pages at a time to generate a comparison result, the processing unit selecting a recording medium size based upon the comparison result according to a predetermined rule; and a printer connected to the processing unit for printing the two consecutive pages on a recording medium of the selected recording medium size, wherein when the comparison result indicates two different sizes, a first one of the two consecutive pages is printed on the front side of the recording medium of a corresponding one of the two different sizes and a second one of the two consecutive pages is printed on the front side of the recording medium of the other one of the two different sizes, wherein when the comparison result indicates a common size, a first one of the two consecutive pages is printed on the front side of the recording medium of the common size and a second one of the two consecutive pages is printed on the back side of the same recording medium.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a block diagram illustrating one preferred embodiment of the communication device according to the current invention.

FIG. 2 is a diagram illustrating a file structure of a document file according to the current invention.

FIG. 3 is a flow chart illustrating steps involved in a first preferred process of printing at the communication device according to the current invention.

FIGS. 4A through 4C are diagrams illustrating the exemplary print outs from the above described preferred process of the double-side printing according to the current invention.

FIG. 5 is a flow chart illustrating steps involved in a second preferred process of double-side printing according to the current invention.

FIGS. 6A through 6C are diagrams illustrating the exemplary print outs from the above described second preferred process of the double-side printing according to the current invention.

FIG. 7 is a flow chart illustrating steps involved in a third preferred process of double-side printing according to the current invention.

FIGS. 8A through 8C are diagrams illustrating the exemplary print outs from the above described third preferred process of the double-side printing according to the current invention.

FIG. 9 is a flow chart illustrating steps involved in a fourth preferred process of double-side printing according to the current invention.

FIGS. 10A through 10D are diagrams illustrating the exemplary print outs from the above described fourth preferred process of the double-side printing according to the current invention.

FIG. 11 is a flow chart illustrating steps involved in a fifth preferred process printing multiple pages of a document according to a print out sequence.

### DETAILED DESCRIPTION OF THE PREFERRED EMBODIMENT(S)

Based upon incorporation by external reference, the current application incorporates all disclosures in the corresponding foreign priority document (JAPA2002-175162) from which the current application claims priority.

Referring now to the drawings, wherein like reference numerals designate corresponding structures throughout the views, and referring in particular to FIG. 1, a block diagram illustrates one preferred embodiment of the communication device according to the current invention. The communication device 100 further includes an image compression decompression unit (DCR) 101, an image memory unit 102, a system memory unit 103 for storing system management data, a display/operation unit 104 having a liquid crystal display and operational buttons, a system control unit 015 for controlling the entire system, a line buffer 106 for data transmission memory, a image reading unit 107 for optically reading originals, an automatic document feeder (ADF) 109 equipped with an original width sensor 108, a printing unit 110 for printing character data on recording medium such as paper, a paper supply unit 111 for setting double-side paper supplier and recording paper, a real time clock (RTC) 112 having a clock, a communication control unit (CCU) 113, a modem 114 for detecting and outputting various tones for modulation and demodulation, and a network control unit (NCU) 115. The above units and devices are connected by internal busses 116.

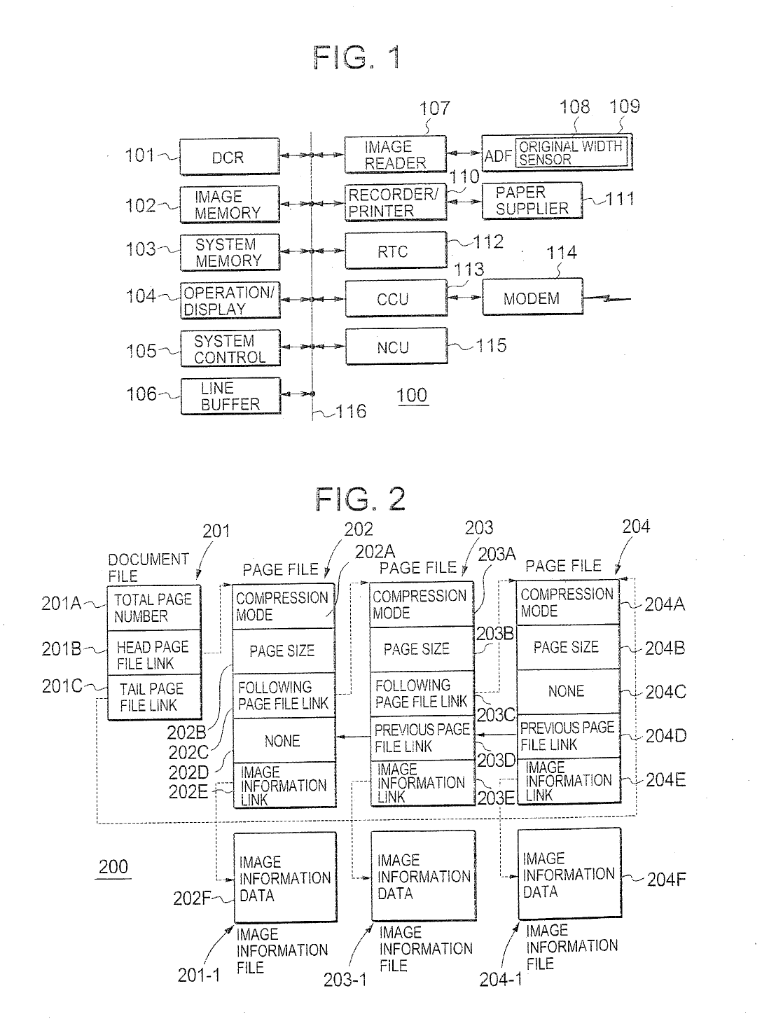

Now referring to FIG. 2, a diagram illustrates a descriptive data file structure of a document file according to the current invention. The document file contains information for managing the entire received document 200. First, the total page number 201A is sent to a number of page files 202, 203 and 204 that is connected. The example as show in FIGURE is three. The head or start page file link 201B has link information for indicating the location of the head file 202. To follow the order of the generated files, the above location is a starting point. Furthermore, the tailor last page file link 201C contains the link information indicative of the location of the last page file 204. To follow the order of the files from the last page or the sort output, the above location is a starting point. Each of the page files 202, 203 and 204 stores information for managing the corresponding page 202, 203 or 204. The compression modes 202A, 203A and 204A contain the image compression information such as MH, MMR or JBIG.

The page size 202B, 203B or 204B contains page size information such as A4, B4 or A3.The next page file links 202C and 203C contain the information on the location of a next page file, and this information is used to follow the files in the order of their generation. However, the next page file link 204C contains “NIL” to indicate the absence of a next page file. Similarly, the previous page file links 203D and 204D contain the information to indicate the location of a previous page file. The above information is used to follow the files in the reverse order of their generation. However, the previous page file link 202D contains “NIL” to indicate the absence of a previous page file. The image information links 202E, 203E and 204E contain the information to indicate the corresponding location of the image infonnation data 202F, 203F and 204F, the are stored in image files 202-1, 203-1 and 204-1.

The above described the document file 201 and the page files 202, 203 and 204 are stored in the system memory 103 as shown in FIG. 1 while the image files 201-1, 203-1 and 204-1 are stored in the image information memory 102. Upon receiving in the memory, the system control 105 generates the document file and the page file for each received page. Each page of the image information is stored in the image information memory 102.

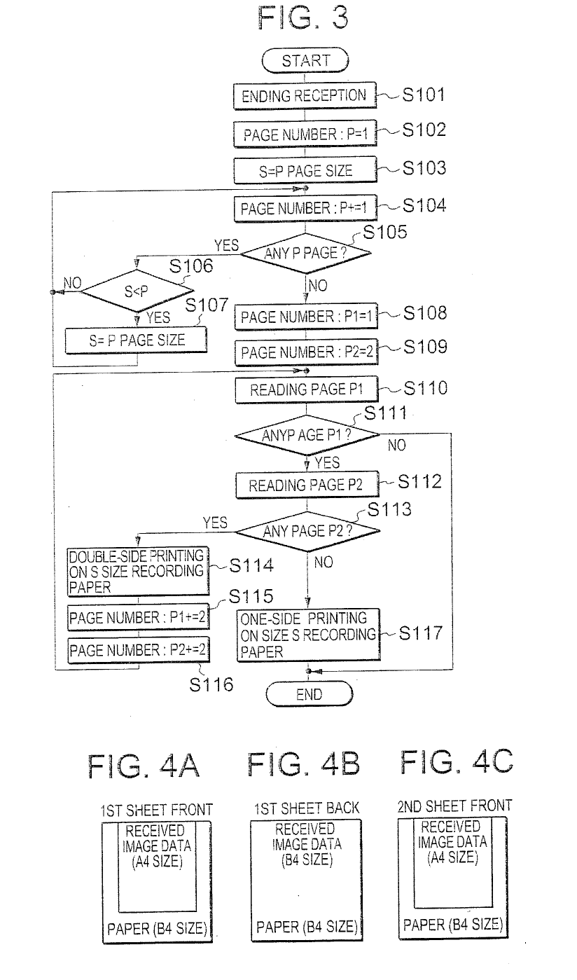

Now referring to FIG. 3, a flow chart illustrates steps involved in a first preferred process of printing at the communication device according to the current invention. In the following description of the first preferred process, it is assumed that the first page is in A4 size, the second page in B4 size and the third page in A4 size. In the following description, the steps are also described with respect to the components as described in FIGS. 1 and 2. After data reception is completed in a step S101, the system control 105 of FIG. 1 sequentially follows the page files from the start page or page number P=1 of the document file based upon the corresponding page file link. That is, the page number P is set to 1 to search the first page in a step S102. Since there is no page size to compare for the first page, the page size of the first page is assigned to have the maximal page size, S in a step S103. Subsequently, the number of page P is set to 2 or the second page in a step S104. It is determined whether a second page or a following page after the first page exists in a step S105. If it is determined that the following page does not exist in the step S105, the maximal page size is assumed to be the page size of the first page. On the other hand, if it is determined in the step S105 that the second page exists, the page size is compared between the first page and the second page in a step S106. If the first page size S is larger than the second page size (P), the maximal page size maintains the first page size in the negative path following the step S106. On the other hand, if the second page size is larger than the first page size, the maximal page size is the second page size in a step S107. As described above, the page size of each page file is checked until the last page, and the largest page size (=S) is determined. In the current example, the second page size of B4 is the largest size.

Subsequently, the system control 105 inquires into the printer 108 whether the recording paper of the maximal size exists. As noted above, in the current example, it is determined whether the B4 paper exists. When the desired paper exists, the system control 105 reads the first page image information data from the image information memory 102, and DCR101 regenerates the image information data. The regenerated data is placed in the line buffer 106 of FIG. 1 and is transferred to the printer 108. Upon finishing one page of the data to the printer 108, the printer 108 writes the data on the paper of the previously selected paper size of the maximal page size from the paper supply unit 111. In the current example, since the first page is A4 size, the A4 data is written on the B4 size recording paper. If the odd-number page or front is designated as P 1, by sequentially incrementing P1 by +2, P1 becomes from the first page to the third page and then the fifth page. By the same token, if the even-number page or back is designated as P2, by sequentially incrementing P2 by +2, P2 becomes from the second page to the fourth page and then the sixth page. First, P1 is set to the first page in a step S108 while P2 is set to the second page in a step S109.

Still referring to FIG. 3, when both the first page and the second page exist as tested in steps S111 and S113, the first and second pages are read in steps S110 and S112, and the first and second pages are printed on both sides of recording paper of the maximal page size in a step S114. In the paper supply unit 111, the previously printed or recorded paper is half turned so that it is ready for printing its back side. The back side printing is the same as the front side printing. In the current example, since the second page is B4 size, B4 data is printed on the back of the B4-size paper. Thus, the double-side printing is completed, and the printer 108 outputs the recording paper. The above described steps are repeated until all pages are completed by sequentially incrementing the odd-number page P1 and the even-number page P2 by +2 respectively in steps S115 and S116. When it is determined that the P1 or odd-number page no longer exists in the step S111, the preferred process terminates. However, when it is determined that the P2 or even-number page no longer exists in the step S113, single-side printing is performed on the maximal-size paper in a step S117.

Now referring to FIG. 4, diagrams illustrate the exemplary print outs from the above described first preferred process of the double-side printing according to the current invention. In summary, the double-side printing is performed using the maximal page-size paper among the pages of various sizes. In particular, FIG. 4A shows the A4 image data is printed on the front side of the first sheet of the B4 size paper while FIG. 4B shows the B4 image data is printed on the back side of the first sheet of the same B4 size paper. Lastly, FIG. 4C shows that the A4 image data is printed on the front side of the second sheet of the B4 size paper.

Now referring to FIG. 5, a flow chart illustrates steps involved in a second preferred process of double-side printing according to the current invention. In the following description, an example assumes that the first page is in A4 size, the second page in B4 size and the third page in A4 size. In the following description, the steps are also with respect to the components as described in FIGS. 1 and 2. After the data reception is completed in a step S201, the system control 105 of FIG. 1 sequentially follows the page files from the start or head page (page number P=1) of the document file based upon page file links. That is, the odd-number page P1 is set to 1 to search the first page in a step S202. Furthermore, the even-number page P2 is set to 2 to search the second page in a step S203. The first page is attempted to be read in steps S204, and it is determined in a S205 whether the first page exists. When it is determined in the step S205 that there is no first page, the preferred process terminates its process. On the other hand, when it is determined that the first page exists in the step S205, the second page size is attempted to be read in a step S206, and it is determined in a S207 whether the second page exists. If the second page does not exist, the preferred process proceeds to a step S215, where the first page image data is printed on a single-side of paper of the first page size, and the preferred process terminates.

Still referring to FIG. 5, in case the first page and the second page exist, the first page size is compared to the second page size in a step S208. If the first page size, the front size and the second page size, the back size are the same in the step S208, the images are printed on the front and back sides of the paper of the same size in a step S209. On the other hand, if it is determined in the steps S208 and S210 that the first page size is larger than the second page size, the double-side printing is performed on the first-page size paper in a step S211. Lastly, if it is determined in the steps S208 and S210 that the first page size is smaller than the second page size, the double-side printing is performed on the second-page-size paper in a step S212. As described above, two pages are processed at a time to select a larger paper size, and the two pages are printed on the front and back sides of the selected larger-size paper. In the current example, since the second page size of B4 is larger than the first page size of A4, the B4 paper is selected for double-side printing.

The system control 105 inquires into the printer 108 whether the recording paper of the larger size or the maximal size exists. As noted above, in the current example, it is determined whether the B4 paper exists. When the desired paper exists, the system control 105 reads the first page image information data from the image information memory 102, and DCR101 regenerates the image information data. The regenerated data placed in the line buffer 106 of FIG. 1 and is transferred to the printer 108. Upon finishing one page of the data to the printer 108, the printer 108 writes the data on the paper of the previously selected paper sizes of the larger page size in the document file from the paper supply unit 111. In the current example, since the first page is A4 size, the A4 data is written on the B4 recording paper. If the odd-number page or front is designated as P1, by sequentially incrementing P1 by +2 as in a step 213, P1 becomes from the first page to the third page and then the fifth page. By the same token, if the even number page or back is designated as P2, by sequentially incrementing P2 by +2 in a step 214, P2 becomes from the second page to the fourth page and then to the sixth page.

Still referring to FIG. 5, during the double side printing, in the paper supply unit 111, the previously printed or recorded paper is half turned so that it is ready for printing its back side. The back side printing is the same as the front side printing. In the current example, since the second page is B4 size, A4 data is printed on the front side of the B4-size paper, and B4 data is printed on the back of the B4-size paper. Thus, the double-side printing is completed, and the printer 108 outputs the recording paper. On the front side of a second sheet of A4 size paper, the A4 data from the third page is printed. The above steps are repeated until all pages are printed. In contrast to the first preferred process where a paper size is selected for double-side printing based upon the largest data size, the second preferred process selects a paper size of the larger of the two pages to be printed on the front and back sides.

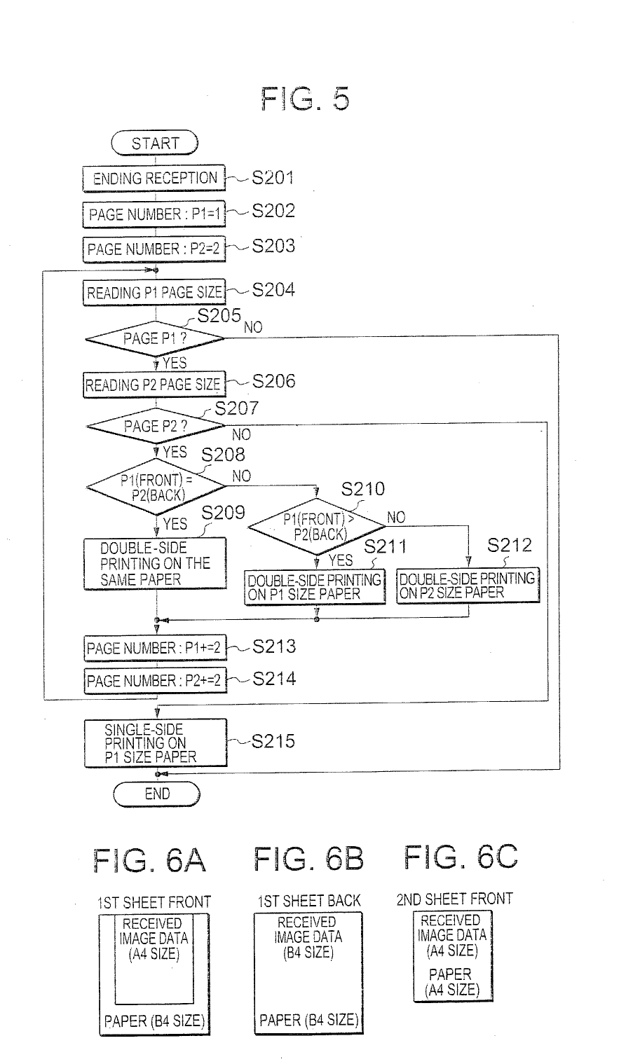

Now referring to FIG. 6, diagrams illustrate the exemplary print outs from the above described second preferred process of the double-side printing according to the current invention. In summary, the double-side printing is performed using the larger page-size paper between the two consecutive pages. In particular, FIG. 6A shows the A4 image data is printed on the front side of the first sheet of the B4 size paper while FIG. 6B shows the B4 image data is printed on the back side of the first sheet of the same B4 size paper. Lastly, FIG. 6C shows that the A4 image data is printed on the front side of the second sheet of the A4 size paper.

Now referring to FIG. 7, a flow chart illustrates steps involved in a third preferred process of double-side printing according to the current invention. In the following description, an example assumes that the first page is in A4 size, the second page in B4 size and the third page in A4 size. In the following description, the steps are also with respect to the components as described in FIGS. 1 and 2. After the data reception is completed in a step S301, the system control 105 of FIG. 1 sequentially follows the page files from the start or head page (page number P=1) of the document file based upon page file links. That is, the odd-number page P1 is set to 1 to search the first page in a step S302. Furthermore, the even-number page P2 is set to 2 to search the second page in a step S303. The first page is attempted to be read in steps S304, and it is determined in a S305 whether the first page exists. When it is determined in the step S305 that there is no first page, the preferred process terminates its process. On the other hand, when it is determined that the first page exists in the step S305, the second page size is attempted to be read in a step S306, and it is determined in a S307 whether the second page exists. If the second page does not exist, the third preferred process proceeds to a step S316, where the first page image data is printed on a single-side of paper of the first page size, and the preferred process terminates.

Still referring to FIG. 7, in case the first page and the second page exist, the first page size is compared to the second page size in a step S308. If the first page size, the front size and the second page size, the back size are the same in the step S308, the images are printed on the front and back sides of the paper of the same size in a step S309. On the other hand, if it is determined in the steps S308 and S310 that the first page size is larger than the second page size, the double-side printing is performed on the smaller second-page size paper in steps 311 and 312. In the step 311, the first page data is reduced to the selected second page size before printing on the front side of the second page size paper. In the step 312, the second page data is printed on the back side of the second page size paper without a size change. On the other hand, if it is determined in the steps S308 and S310 that the first page size is smaller than the second page size, the double-side printing is performed on the smaller first page size paper in steps 313A and 313B. In the step 313A, the first page data is printed on the front side of the first page size paper without a size change. In the step 313B, the second page data is reduced to the selected first page size before printing on the back side of the first page size paper. As described above, two pages are processed at a time to select a smaller paper size, and the two pages are printed on the front and back sides of the selected smaller-size paper. In the current example, since the first page size of A4 is smaller than the second page size of B4, the A4 paper is selected for double-side printing.

The system control 105 inquires into the printer 108 whether the recording paper of the smaller size or the minimal size exists. As noted above, in the current example, it is determined whether the A4 paper exists. When the desired paper exists, the system control 105 reads the first page image information data from the image information memory 102, and DCR101 regenerates the image information data. The regenerated data placed in the line buffer 106 of FIG. 1 and is transferred to the printer 108. Upon finishing one page of the data to the printer 108, the printer 108 writes the data on the paper of the previously selected paper sizes of the smaller page size in the document file from the paper supply unit 111. In the current example, since the first page is A4 size, the A4 data is written on the A4 recording paper. If the odd-number page or front is designated as P1, by sequentially incrementing P1 by +2 as in a step 314, P1 becomes from the first page to the third page and then the fifth page. By the same token, if the even number page or back is designated as P2, by sequentially incrementing P2 by +2 in a step 315, P2 becomes from the second page to the fourth page and then to the sixth page.

Still referring to FIG. 7, during the double side printing, in the paper supply unit 111, the previously printed or recorded paper is half turned so that it is ready for printing its back side. The back side printing is the same as the front side printing. In the current example, since the first page is A4 size, A4 data is printed on the front side of the A4-size paper, and B4 data is reduced and printed on the back of the A4-size paper. Thus, the double-side printing is completed, and the printer 108 outputs the recording paper. On the front side of a second sheet of A4 size paper, the A4 data from the third page is printed. The above steps are repeated until all pages are printed. In contrast to the second preferred process where a paper size is selected for double-side printing based upon the larger data size of two consecutive pages, the third preferred process selects a paper size of the smaller of the two pages to be printed on the front and back sides.

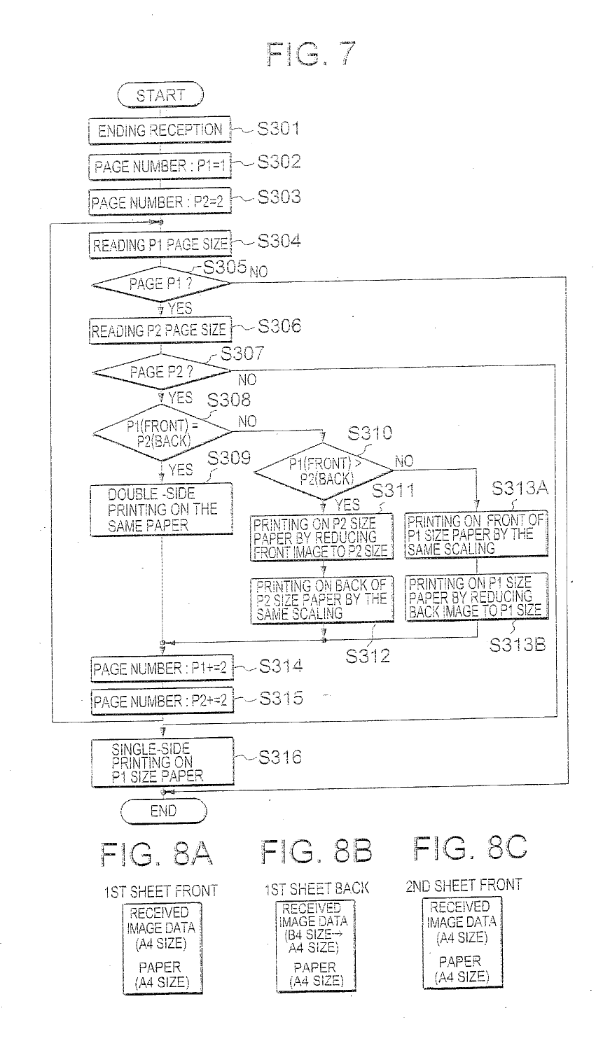

Now referring to FIG. 8, diagrams illustrate the exemplary print outs from the above described third preferred process of the double-side printing according to the current invention. In summary, the double-side printing is performed using the smaller page-size paper between the two consecutive pages. In particular, FIG. 8A shows the A4 image data is printed on the front side of the first sheet of the A4 size paper while FIG. 8B shows the B4 image data is reduced and printed on the back side of the first sheet of the same A4 size paper. Lastly, FIG. 8C shows that the A4 image data is printed on the front side of the second sheet of the A4 size paper.

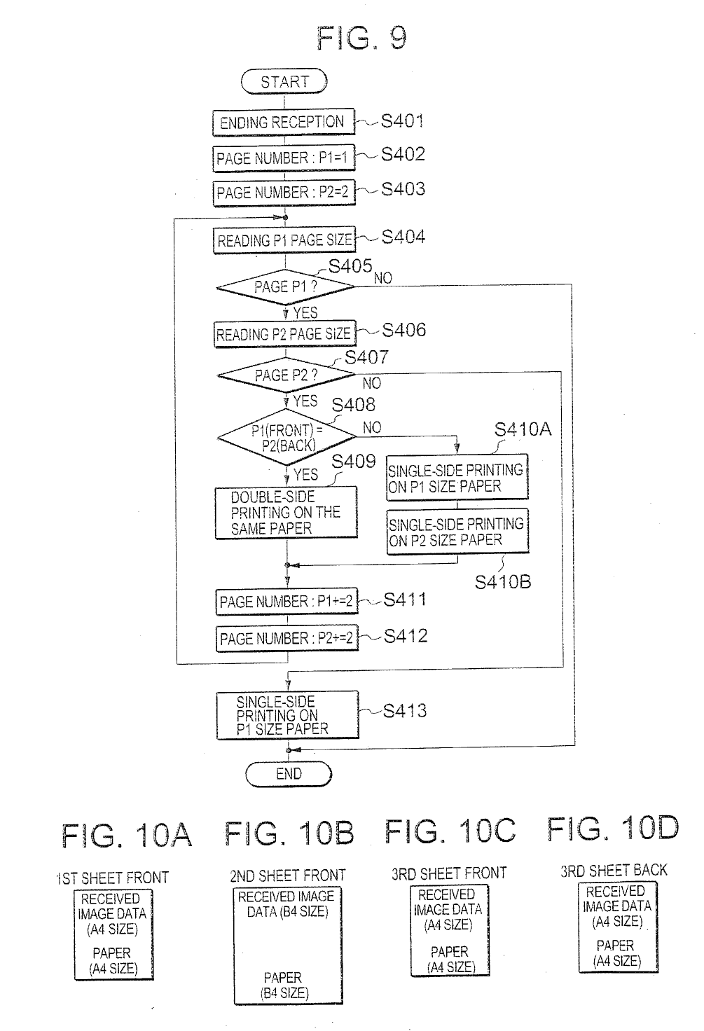

Now referring to FIG. 9, a flow chart illustrates steps involved in a fourth preferred process of double-side printing according to the current invention. In the following description, an example assumes that the first page is in A4 size, the second page in B4 size, the third page in A4 size and the fourth page is A4. In the following description, the steps are also with respect to the components as described in FIGS. 1 and 2. After the data reception is completed in a step S401, the system control 105 of FIG. 1 sequentially follows the page files from the start or head page (page number P=1) of the document file based upon page file links. That is, the odd-number page P1 is set to 1 to search the first page in a step S402. Furthermore, the even-number page P2 is set to 2 to search the second page in a step S403. The first page is attempted to be read in steps S404, and it is determined in a S405 whether the first page exists. When it is determined in the step S405 that there is no first page, the preferred process terminates its process. On the other hand, when it is determined that the first page exists in the step S405, the second page size is attempted to be read in a step S406, and it is determined in a S407 whether the second page exists. If the second page does not exist, the fourth preferred process proceeds to a step S413, where the first page image data is printed on a single-side of paper of the first page size, and the preferred process terminates.

Still referring to FIG. 9, in case the first page and the second page exist, the first page size is compared to the second page size in a step S408. If the first page size, the front size and the second page size, the back size are the same in the step S408, the images are printed on the front and back sides of the paper of the same size in a step S409. On the other hand, if it is determined in the step S408 that the first page size is not the same as the second page size, the single-side printing is performed on the corresponding page size paper in steps 410A and 410B. In the step 410A, the first page data is printed on the front side of the first page size paper without a size change. In the step 410B, the second page data is printed on the front side of the second page size paper without a size change. As described above, two pages are processed at a time to select a corresponding paper size, and the two pages are printed on the front and back sides of the selected same size paper only when the two pages contain the same size. In the current example, since the first page size is A4 while the second page size is B4, the A4 paper is selected for the first page and the B4 paper is selected for the second page.

The system control 105 inquires into the printer 108 whether the recording paper of the corresponding size or the minimal size exists. As noted above, in the current example, it is determined whether the A4 paper exists. When the desired paper exists, the system control 105 reads the first page image information data from the image information memory 102, and DCR101 regenerates the image information data. The regenerated data placed in the line buffer 106 of FIG. 1 and is transferred to the printer 108. Upon finishing one page of the data to the printer 108, the printer 108 writes the data on the paper of the previously selected paper size in the document file from the paper supply unit 111. In the current example, since the first page is A4 size, the A4 data is written on the front of the A4 recording paper. If the odd-number page or front is designated as P1, by sequentially incrementing P1 by +2 as in a step 411, P1 becomes from the first page to the third page and then the fifth page. By the same token, if the even number page or back is designated as P2, by sequentially incrementing P2 by +2 in a step 412, P2 becomes from the second page to the fourth page and then to the sixth page.

Still referring to FIG. 9, during the double side printing, in the paper supply unit 111, the previously printed or recorded paper is half turned so that it is ready for printing its back side. The back side printing is the same as the front side printing. In the current example, since the third and fourth pages are in A4 size, the third and fourth pages are printed on the front and back sides of the same A4 size paper. Thus, the double-side printing is completed, and the printer 108 outputs the recording paper. The above steps are repeated until all pages are printed. In contrast to the third preferred process where a paper size is selected for double-side printing based upon the smaller data size of two consecutive pages, the fourth preferred process selects the same paper size for double-side printing if the two pages of the same size.

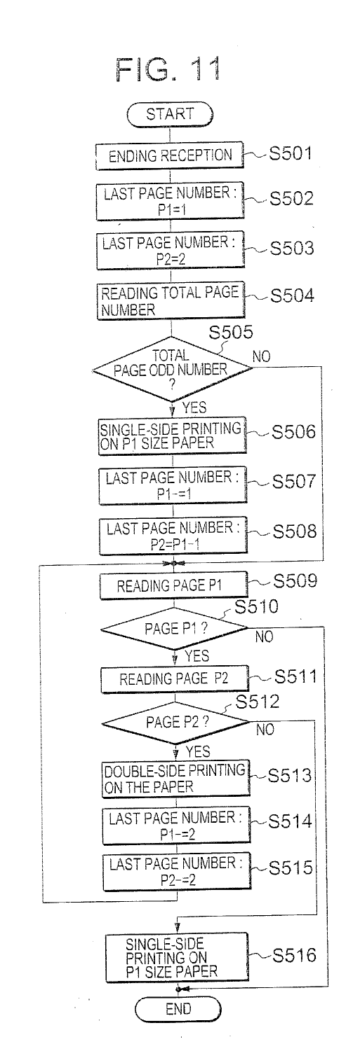

Now referring to FIG. 10, diagrams illustrate the exemplary print outs from the above described fourth preferred process of the double-side printing according to the current invention. In summary, the double-side printing is performed using the same page-size paper if the two consecutive pages have the same size. In particular, FIG. 10A shows the A4 image data is printed on the front side of the first sheet of the A4 size paper while FIG. 10B shows the B4 image data is printed on the front side of the second sheet of the B4 size paper. FIGS. 10C and 10D respectively show that the A4 image data is printed on the front and back sides of the second sheet of the A4 size paper.

Now referring to FIG. 11, a flow chart illustrates steps of printing multiple pages of a document according to a sorted print out sequence. The received image data as shown in FIGS. 1 and 2 are now printed in such a manner that the pages are automatically sorted by outputting in a reverse order. In a step S501, the image data is received. The last page numbers P1 and P2 are respectively set to 1 and 2 in steps S502 and S503. Based upon the document file 201, the total number of pages is determined using the file links to find the last page file in a step S504. In the step S504, P1 and P2 are now assigned to front and back of the last page or the last two pages. It is further determined in a step S505 whether the total number of pages is even or odd. If it is even, the fifth preferred process proceeds to a step S509. On the other hand, if it is odd, the last page is printed on a single side of P1 paper size paper in a step S506. The P1 and P2 page indexes are now decremented by one in steps 507 and 508.

Still referring to FIG. 11, in steps S509 and S510, the last first page P1 is attempted to be read in, and it is determined whether or not the first page P1 exists. It the first page does not exist, the preferred process terminates. On the other hand, if the first page exists, in steps S511 and S512, the last second page P2 is attempted to be read in, and it is determined whether or not the second page P2 exists. If the second page does not exist, the first page is printed on one side of P1 size paper in a step S516. If both the first and second pages P1 and P2 exist, the two pages are printed on a front and a back of the same paper in a step 513. The step 513 determines an appropriate paper size according to a selected predetermined rule from those as described with respect to the above described first through fourth preferred processes. Subsequently, the last page indexes P1 and P2 are decremented by two in steps 514 and 515. The above described steps S509 through S515 are repeated until the first page no longer exists.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of performing double-side printing, comprising the steps of:
receiving image data having a plurality of pages of multiple sizes to be printed with a corresponding descriptive data file in a predetermined format, the descriptive data file having at least information on an image size of each of the pages;
comparing the image size of at least two consecutive ones of the pages to generate a comparison result;
selecting a recording medium size based upon the comparison result according to a predetermined rule; and
printing the pages on a front side and a back side of a recording medium of the selected recording medium size.

2. The method of performing double-side printing according to claim 1 wherein the two consecutive pages are compared at a time in said comparing step.

3. The method of performing double-side printing according to claim 2 wherein the comparison result indicates the larger size.

4. The method of performing double-side printing according to claim 3 wherein if the two consecutive pages are different in size, the size of a smaller one of the two consecutive pages is enlarged to the larger size.

5. The method of performing double-side printing according to claim 4 wherein the two consecutive pages are printed at a time on the front side and the back side of the recording medium of the larger size.

6. The method of performing double-side printing according to claim 2 wherein the comparison result indicates the smaller size.

7. The method of performing double-side printing according to claim 6 wherein if the two consecutive pages are different in size, the size of a larger one of the two consecutive pages is reduced to the smaller size.

8. The method of performing double-side printing according to claim 7 wherein the two consecutive pages are printed at a time on the front side and the back side of the recording medium of the smaller size.

9. The method of performing double-side printing according to claim 1 wherein the comparison result indicates the largest size.

10. The method of performing double-side printing according to claim 9 wherein if any of the consecutive pages is different in size, the size of every corresponding smaller one of the consecutive pages is enlarged to the largest size.

11. The method of performing double-side printing according to claim 10 wherein the consecutive pages are printed on the front side and the back side of the recording medium of the largest size.

12. The method of performing double-side printing according to claim 1 wherein the comparison result indicates the smallest size.

13. The method of performing double-side printing according to claim 12 wherein if any of the consecutive pages is different in size, the size of every corresponding larger one of the consecutive pages is reduced to the smallest size.

14. The method of performing double-side printing according to claim 13 wherein the consecutive pages are printed on the front side and the back side of the recording medium of the smallest size.

15. The method of performing double-side printing according to claim 1 wherein when a last one of the pages is odd-number, printing the last odd page only on the front side of the recording medium of the selected recording medium size.

16. The method of performing double-side printing according to claim 1 wherein further comprising an additional step of storing the received image data prior to said comparing step.

17. A method of performing double-side printing, comprising the steps of:
inputting image data having a plurality of pages of multiple sizes to be printed with a corresponding descriptive data file in a predetermined format, the descriptive data file having at least information on an image size of each of the pages;
comparing the image size of two consecutive ones of the pages at a time to generate a comparison result;
selecting a recording medium size based upon the comparison result according to a predetermined rule; and
printing the two consecutive pages on a recording medium of the selected recording medium size, wherein when the comparison result indicates two different sizes, a first one of the two consecutive pages is printed on the front side of the recording medium of a corresponding one of the two different sizes and a second one of the two consecutive pages is printed on the front side of the recording medium of the other one of the two different sizes, wherein when the comparison result indicates a common size, a first one of the two consecutive pages is printed on the front side of the recording medium of the common size and a second one of the two consecutive pages is printed on the back side of the same recording medium.

18. The method of performing double-side printing according to claim 17 wherein when there is only one page to compare in said comparison step, the single page is printed on the front side of the recording medium of the selected recording medium size.

19. A system for performing double-side printing, comprising:
a memory for receiving image data having a plurality of pages of multiple sizes to be printed with a corresponding descriptive data file in a predetermined format, the descriptive data file having at least information on an image size of each of the pages;
a processing unit connected to said memory for comparing the image size of at least two consecutive ones of the pages to generate a comparison result, said processing unit selecting a recording medium size based upon the comparison result according to a predetermined rule; and
a printer connected to said processing unit for printing the pages on a front side and a back side of a recording medium of the selected recording medium size.

20. The system for performing double-side printing according to claim 19 wherein said processing unit compares the two consecutive pages at a time.

21. The system for performing double-side printing according to claim 20 wherein the comparison result indicates the larger size.

22. The system for performing double-side printing according to claim 21 wherein if the two consecutive pages are different in size, said processing unit enlarging the size of a smaller one of the two consecutive pages to the larger size.

23. The system for performing double-side printing according to claim 22 wherein said printer prints the two consecutive pages at a time on the front side and the back side of the recording medium of the larger size.

24. The system for performing double-side printing according to claim 20 wherein the comparison result indicates the smaller size.

25. The system for performing double-side printing according to claim 24 wherein if the two consecutive pages are different in size, said processing unit reduces the size of a larger one of the two consecutive pages to the smaller size.

26. The system for performing double-side printing according to claim 25 wherein said printer prints the two consecutive pages at a time on the front side and the back side of the recording medium of the smaller size.

27. The system for performing double-side printing according to claim 19 wherein the comparison result indicates the largest size.

28. The system for performing double-side printing according to claim 27 wherein if any of the consecutive pages is different in size, said processing unit enlarges the size of every corresponding smaller one of the consecutive pages to the largest size.

29. The system for performing double-side printing according to claim 28 wherein said printer prints the consecutive pages on the front side and the back side of the recording medium of the largest size.

30. The system for performing double-side printing according to claim 19 wherein the comparison result indicates the smallest size.

31. The system for performing double-side printing according to claim 30 wherein if any of the consecutive pages is different in size, said processing unit reduces the size of every corresponding larger one of the consecutive pages to the smallest size.

32. The system for performing double-side printing according to claim 31 wherein said printer prints the consecutive pages on the front side and the back side of the recording medium of the smallest size.

33. The system for performing double-side printing according to claim 18 wherein when a last one of the pages is odd-number, said printer prints the last odd page only on the front side of the recording medium of the selected recording medium size.

34. A system for performing double-side printing, comprising:
a memory for receiving image data having a plurality of pages of multiple sizes to be printed with a corresponding descriptive data file in a predetermined format, the descriptive data file having at least information on an image size of each of the pages;
a processing unit connected to said memory for comparing the image size of two consecutive ones of the pages at a time to generate a comparison result, said processing unit selecting a recording medium size based upon the comparison result according to a predetermined rule; and
a printer connected to said processing unit for printing the two consecutive pages on a recording medium of the selected recording medium size, wherein when the comparison result indicates two different sizes, a first one of the two consecutive pages is printed on the front side of the recording medium of a corresponding one of the two different sizes and a second one of the two consecutive pages is printed on the front side of the recording medium of the other one of the two different sizes, wherein when the comparison result indicates a common size, a first one of the two consecutive pages is printed on the front side of the recording medium of the common size and a second one of the two consecutive pages is printed on the back side of the same recording medium.

35. The system for performing double-side printing according to claim 34 wherein when there is only one page to compare in said comparison step, said printer prints the single page on the front side of the recording medium of the selected recording medium size.
